(19) United States
(12) Patent Application Publication
(10) Pub. No.: US 2005/0192808 A1
(43) Pub. Date: Sep. 1, 2005

(54) Use of speech recognition for identification and classification of images in a camera-equipped mobile handset

(75) Inventor: Edward Masami Sugiyama, Vancouver, WA (US)

Correspondence Address: Robert D. Varitz;ROBERT D. VARITZ, P.C., 2007 S.E. Grant Street, Portland, OR, 97214, US

(73) Assignee: Sharp Laboratories of America, Inc.

(21) Appl. No.: 10/789,286

(22) Filed: Feb. 26, 2004

(51) Int. Cl. G10L 11/00

(52) U.S. Cl. 704/270

(57) ABSTRACT

A method of identifying an image file using a voice recognition system in a camera-equipped mobile communication device includes capturing an image in an image file with a digital camera in the mobile communication device; adding a voice tag to the image file; storing the image file and voice tag in the mobile communication device; activating retrieval of the image by speaking the associated voice tag; processing the voice tag input by the voice recognition mechanism of the mobile communication device; searching stored images for the input voice tag; and displaying the image associated with the input voice tag.

### FIELD OF INVENTION

This invention relates to mobile communication handsets, and specifically to camera-equipped GSM handsets which store images therein.

### BACKGROUND OF THE INVENTION

Current mobile camera-equipped handsets, including the Panasonic GU-87, Nokia 3650, Samsung V205, and the Sharp GX-20, do not automatically categorize or name captured images into separate folders or albums. Instead, the captured images are stored in the handset under a unique file name which is generated internally by the handset. The file name is arbitrary with respect to the image, and does not aid a user in finding an image, or a group of images, which is stored in the handset, rendering location of any specific image quite difficult, particularly where the handset does not have a thumbnail preview capability.

One way to provide a user-known, or descriptive, file name for an image is to manually enter the filename, using the keypad on the handset. The disadvantage to this method is that a manual key entry method is quite cumbersome. For example, for a user to enter the word “soccer”, the user must push the ‘7’ key four times, the ‘6’ key three times, the ‘2’ key three times, pause, the ‘2’ key three times, the ‘6’ key three times, the ‘3’ key two times, and the ‘7’ key three times. While optimized keypad entry methods, e.g., T9, are available, such methods are still cumbersome. Hence these solutions are not feasible to provide rapid naming of images.

U.S. Pat. No. 6,178,403 to Majaniemi, for Mobile communication devices having speech recognition functionality, granted May 21, 2002 describes a hand-held data acquisition device including a display presenting at least one of (1) an address book, (2) a date book, (3) a memo pad, (4) a to-do list, (5) a contact manager, (6) an expense tracker, (7) an e-mail client, and (8) a project manager, at least one of which contains multiple data entries. An input device is operatively connected to the device and suitable to receive voice data from the user. The data acquisition device stores the voice data and associates the voice data with at least one of the data items.

U.S. Pat. No. 6,393,403 to Detlef, for Distributed voice capture and recognition system, granted Jan. 23, 2001, describes a mobile telephone having speech recognition and speech synthesis functionality. The telephone has a memory for storing a set of speech recognition templates corresponding to a set of respective spoken commands and a transducer for converting a spoken command into an electrical signal. Signal processing means are provided for analyzing a converted spoken command, together with templates stored in the memory to identify whether or not the converted spoken command corresponds to one of the set of spoken commands. The phone user may select to download, into the phone's memory, a set of templates for a selected language, from a central station via a wireless transmission channel. The reference describes use of speech recognition in the mobile handset to determine if the spoken voice matches a template of commands that is stored in the handset. The voice spoken into the handset is not used as a tag.

U.S. Pat. No. 6,047,257 to Dewaele, for Identification of medical images through speech recognition, granted Apr. 4, 2000, describes an identification station into which data identifying a medical image are input and by means of which the identification data are. associated with the medical image. The identification station is provided with a speech recognition subassembly, and a microphone to allow data input through speech recognition. The reference requires the use of a PC or workstation which is connected to a network. This system uses speech identification data to store the medical images.

U.S. Patent Publication No. 20030117365 of Shteyn, for UI with graphics-assisted voice control system, published Jun. 26, 2003, describes an electronic device having a UI which provides first-user-selectable options. Second-user-selectable options are made available upon selection of a specific one of the first-user-selectable options. An information resolution of the first options, when rendered, differs from the information resolution of the second options when rendered. Also, a first modality of user interaction with the UI for selecting from the first options differs from a second modality of user interaction with the UI for selecting from the second options. The reference describes use of a speech recognition system to display a specific phone number or address that is stored in the device including mobile phones.

U.S. Patent Publication No. 20030163321 of Mauli, for Speech recognition capability for a personal digital assistant, published Aug. 28, 2003, describes a speech recognition module for a personal digital assistant which includes a module housing designed to engage with an accessory feature of the PDA, such as an accessory slot; a microphone for receiving speech commands from a user; and a speech recognition system. A corresponding electrical speech command signal is communicated to the portable computing device, allowing control of the operation of a software application program running on the portable computing device. In particular, menu items may be selected for generation of, e.g., a diet log for the user during a weight control program. This system uses a PDA having speech recognition software. The system will analyzes the voice from the user to control the diet program software.

U.S. Patent Publication No. 20030144843 of Belrose, for Method and system for collecting user-interest information regarding a picture, published Jul. 31, 2003, describes a system wherein a user is presented with an image, either in hard-copy or electronic form. Particular picture features in the image each have associated information which is presented to the user when the user requests such information by, e.g., selecting the picture feature using a feature-selection tool. Should the user select a picture feature for which no information is provided, an identifier of the feature, e.g., its image coordinates, are output to inform the user about the picture and related information. Preferably, to request information about a picture feature, the user, as well as selecting the feature, also inputs a query by voice, e.g., where the selected feature has no associated information, the user query is also sent back to the person involved in providing the picture and related information. The reference describes use of a “voice browser” to access the image or picture from a server. The voice commands may be sent via cell phone and the image sent to the cell phone from the server.

### SUMMARY OF THE INVENTION

A method of identifying an image file using a voice recognition system in a camera-equipped mobile communication device includes capturing an image in an image file with a digital camera in the mobile communication device; adding a voice tag to the image file; storing the image file and voice tag in the mobile communication device; activating retrieval of the image by speaking the associated voice tag; processing the voice tag input by the voice recognition mechanism of the mobile communication device; searching stored images for the input voice tag; and displaying the image associated with the input voice tag.

It is an object of the invention to provide a method of identifying an image file with a voice tag.

Another object of the invention is to identify a stored image without the necessity of manual keypad entry.

A further object of the invention is to provide an image, a group of image, or a video, with an embedded voice tag.

Another object of the invention is to provide voice recognition initiated retrieval of stored, voice-tagged images.

This summary and objectives of the invention are provided to enable quick comprehension of the nature of the invention. A more thorough understanding of the invention may be obtained by reference to the following detailed description of the preferred embodiment of the invention in connection with the drawings.

### BRIEF DESCRIPTION OF THE DRAWINGS

FIG. 1 is a block diagram of the method of the invention.

### DETAILED DESCRIPTION OF THE PREFERRED EMBODIMENTS

The method of the invention “names” the images, wherein images are defined as the digital picture and/or video that a camera-equipped mobile handset captures and stores, in the mobile camera handset by using a voice tag. The voice tag of the method of the invention may be used at a later time to retrieve an image. An advantage of the method of the invention is that the user does not have to make any manual key entries and may use the voice recording capability and the voice detection capability incorporated into the handset to name stored images. In addition, the user may rapidly retrieve and display the images identified by voice tags. After retrieving an image, the image may be presented as part of a slide-show, EMailed to a PC or other image capable device, or transferred to another multi-media device, such as TV.

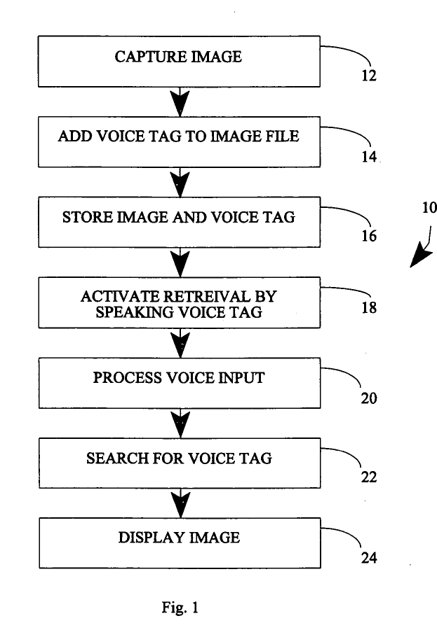

Referring now to FIG. 1, the method of the invention is depicted generally at 10. A digital image is captured 12 using the built-in CCD camera of the mobile handset. Using the codec in the handset, a voice tag is recorded as part of the digital image 14.

To store an image, the user captures the desired image using the camera function of the handset. A voice tag is recorded using the microphone of the handset. If the user is satisfied with the image and the voice tag, the user stores the image and voice tag as a single object in the handset memory 16. In the case of multiple images related to a single event, the user may employ a single voice tag for every image in the set of images for the event.

When the user is ready to extract the image, group of images, or video, the user speaks into the handset, using the voice tag associated with the image. The voice recognition algorithm, standard in handsets to provide voice-activated dialing, analyzes and compares the incoming speech with the voice tag. Matching images are displayed on the handset as a function of the voice tag used. A retrieval process requires the user to speak the exact voice tag into the handset microphone 18. A speech encoder/decoder processes 20 the incoming voice and determines a match with the voice tag 22. Once all of the matches have been found, the images associated with the specific voice tag are displayed 24. The user may then send all of the displayed images to a mail server, to another handset, to a folder or to a PC, without having to preview the images one-by-one. Furthermore, because the images may include video, the desired image may be transmitted to a TV or a video recorder for future viewing. The viewing on a TV includes both video and still images.

Thus, a method and system for identifying and classifying images in a mobile communication device using voice recognition has been disclosed. It will be appreciated that further variations and modifications thereof may be made within the scope of the invention as defined in the appended claims.

1. A method of identifying an image file using a voice recognition system in a camera-equipped mobile communication device, comprising:
capturing an image in an image file with a digital camera in the mobile communication device;
adding a voice tag to the image file;
storing the image file and voice tag in the mobile communication device;
activating retrieval of the image by speaking the associated voice tag;
processing the voice tag input by the voice recognition mechanism of the mobile communication device;
searching stored images for the input voice tag; and
displaying the image associated with the input voice tag.

2. The method of claim 1 wherein a single voice tag is associated with a group of related images.

3. The method of claim 1 wherein the image is a video image.

4. A method of identifying an image file using a voice recognition system in a camera-equipped mobile communication device, comprising:
capturing an image in an image file with a digital camera in the mobile communication device, wherein the image is take from the group of images consisting of single images, groups of images and video;
adding a voice tag to the image file;
storing the image file and voice tag in the mobile communication device;
activating retrieval of the image by speaking the associated voice tag;
processing the voice tag input by the voice recognition mechanism of the mobile communication device;
searching stored images for the input voice tag; and
displaying the image associated with the input voice tag.

5. A method of identifying an image file using a voice recognition system in a camera-equipped mobile communication device, comprising:
capturing an image in an image file with a digital camera in the mobile communication device;
adding a voice tag to the image file; and
storing the image file and voice tag in the mobile communication device.

6. The method of claim 5 which further includes activating retrieval of the image by speaking the associated voice tag;
processing the voice tag input by the voice recognition mechanism of the mobile communication device;
searching stored images for the input voice tag; and
displaying the image associated with the input voice tag.

7. The method of claim 5 wherein a single voice tag is associated with a group of related images.

8. The method of claim 5 wherein the image is a video image.
